(19) United States
(12) Patent Application Publication
(10) Pub. No.: US 2014/0215900 A1
(43) Pub. Date: Aug. 7, 2014

(54) YELLOW JACKET BAIT HOUSE

(71) Applicants: Michael John Parent, Cumming, GA (US); Frederick Arthur Matthews, Cumming, GA (US)

(72) Inventors: Michael John Parent, Cumming, GA (US); Frederick Arthur Matthews, Cumming, GA (US)

(21) Appl. No.: 14/133,494

(22) Filed: Dec. 18, 2013

Related U.S. Application Data
(60) Provisional application No. 61/849,991, filed on Feb. 7, 2013.

(51) Int. Cl. A01M 1/20

(52) U.S. Cl. CPC A01M 1/2016
USPC 43/131

(57) ABSTRACT

A bait house for bringing yellow jackets into proximity to a pesticide which is brought back to the nest. The bait house includes a pair of opposing side panels. The bait house also includes an entrance formed in at least one of the side panels. The entrance is configured to allow a yellow jacket to enter the bait house and allow a yellow jacket to exit the bait house. The bait house further includes an integrally molded bait receptacle attached to the side panels by fold lines. The side panels pivot along the fold lines to engage each other and the central tray form an enclosed volume.

### CROSS-REFERENCE TO RELATED APPLICATIONS

This application claims the benefit of and priority to U.S. Provisional Patent Application Ser. No. 61/849,991 filed on Feb. 7, 2013, which application is incorporated herein by reference in its entirety.

### BACKGROUND OF THE INVENTION

Conventional flying insect traps are ineffective in many ways. For example, they may prevent the insect from exiting the trap. I.e., the insect is lured into the trap and the entrance is configured in such a way that the insect remains inside where it is killed, either through starvation, dehydration or by ingesting poison. This does eliminate the insects which enter the trap but it lets all other members of the nest survive. I.e., only trapped insects are killed while all other members of the nest remain in the area.

In addition, they often use bait or attractants that are placed by the user which can lead to user error. For example, if the user gets any bait or attractant on his/her body or clothing then the undesired insects are actually attracted to the user. This greatly increases the likelihood of stings or bites. Additionally, attractant is often an oily substance that is difficult to remove, even with repeated washings.

Finally, traps are often bulky contraptions. Thus, the user is forced to allocate space to store the trap when not in use, such as in winter months. In reality, this often means that the traps are simply left hanging wherever they were initially placed. This causes the traps to wear out much quicker, since they are left out in the elements.

Accordingly, there is a need in the art for a bait house that allows yellow jackets to return to a nest, taking poison with them that eliminates all nest members. In addition, there is a need in the art for bait which can reduce or eliminate the chances of user error. Further, there is a need in the art for a bait house which can be easily stored.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a bait house for bringing yellow jackets into proximity to a pesticide which is brought back to the nest. The bait house includes a pair of opposing side panels. The bait house also includes an entrance formed in at least one of the side panels. The entrance is configured to allow a yellow jacket to enter the bait house and allow a yellow jacket to exit the bait house. The bait house further includes an integrally molded bait receptacle attached to the side panels by fold lines. The side panels pivot along the fold lines to engage each other and the central tray form an enclosed volume.

Another example embodiment includes a bait house for bringing yellow jackets into proximity to a pesticide which is brought back to the nest. The bait house includes a pair of opposing side panels. The bait house also includes an entrance formed in at least one of the side panels. The entrance is configured to allow a yellow jacket to enter the bait house and allow a yellow jacket to exit the bait house. The bait house further includes an integrally molded bait receptacle attached to the side panels by fold lines. The side panels pivot along the fold lines to engage each other and the central tray form an enclosed volume. The bait house additionally includes an attachment, wherein the attachment is configured to secure the opposing side panels to one another when engaged.

Another example embodiment includes a bait house for bringing yellow jackets into proximity to a pesticide which is brought back to the nest. The bait house includes a pair of opposing side panels. The bait house also includes an entrance formed in at least one of the side panels. The entrance is configured to allow a yellow jacket to enter the bait house and allow a yellow jacket to exit the bait house. The bait house further includes an integrally molded bait receptacle attached to the side panels by fold lines. The side panels pivot along the fold lines to engage each other and the central tray form an enclosed volume. The bait house additionally includes an attachment, wherein the attachment is configured to secure the opposing side panels to one another when engaged. The bait house moreover includes a bait tray within the bait receptacle. The bait tray includes a container containing bait. The bait house moreover includes a hanger, wherein the hanger is configured to allow placement of the bait house by a user.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a top view of an unfolded bait house;

FIG. 1B illustrates a front view of an unfolded bait house;

FIG. 1C illustrates a side view of an unfolded bait house;

FIG. 1D illustrates a top perspective view of an unfolded bait house;

FIG. 1E illustrates a side view of a folded bait house;

FIG. 1F illustrates a front view of a folded bait house;

FIG. 2A illustrates a top view of a bait tray;

FIG. 2B illustrates a side view of a bait tray; and

FIG. 2C illustrates a top perspective view of a bait tray.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

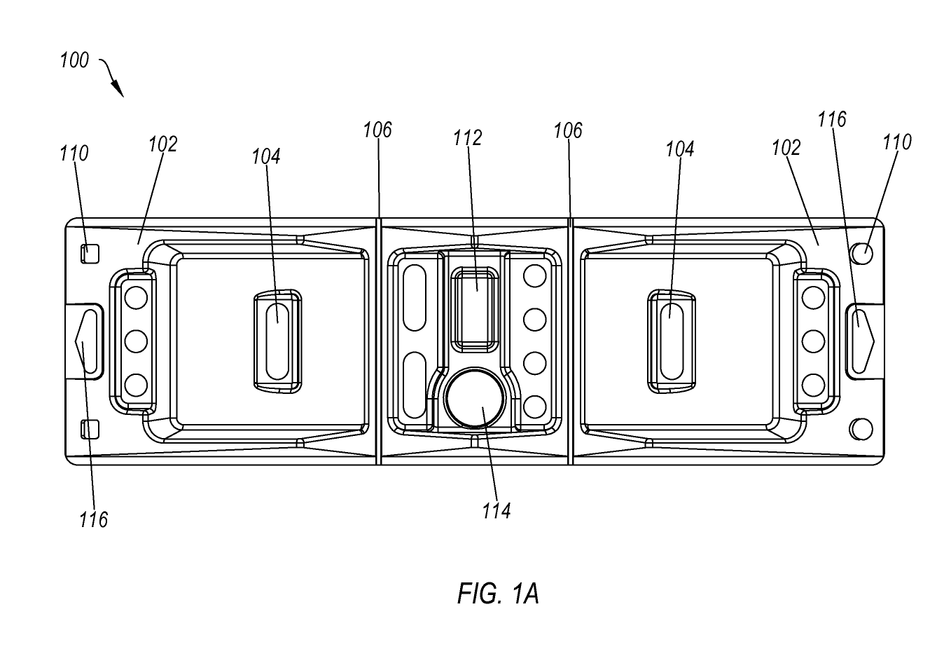

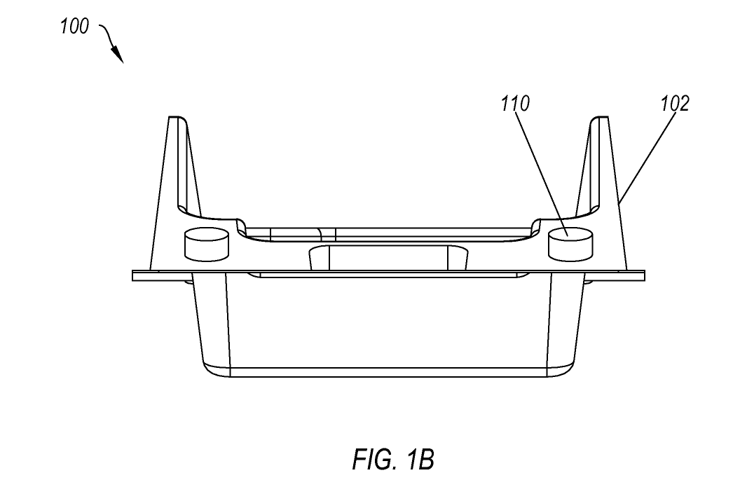

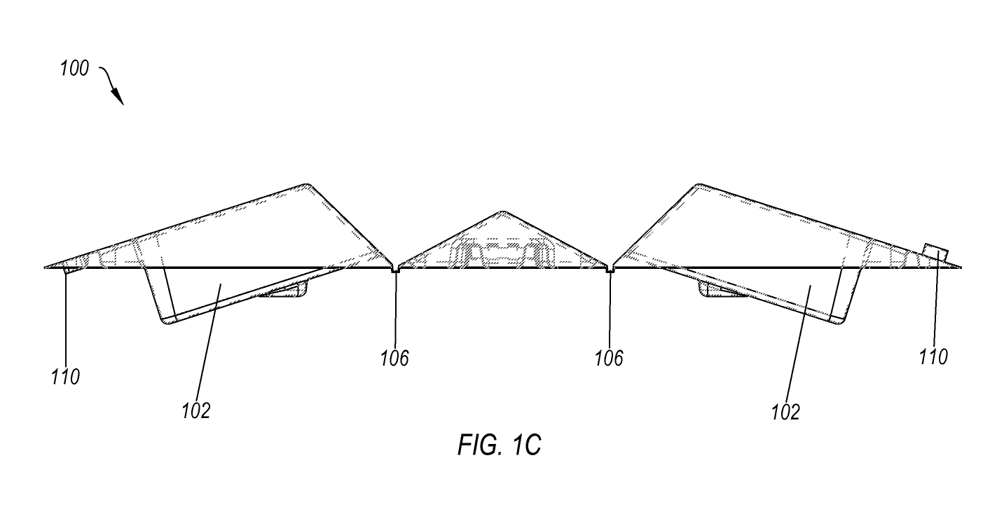

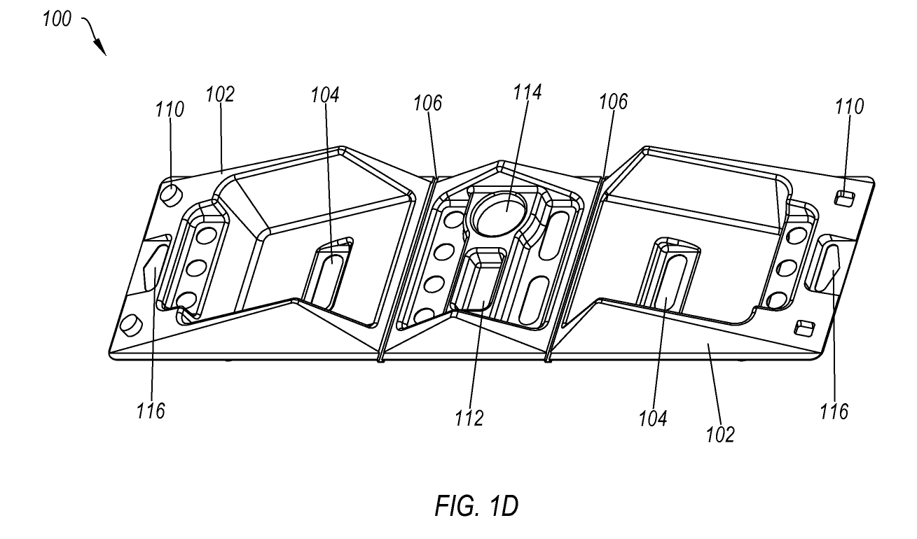

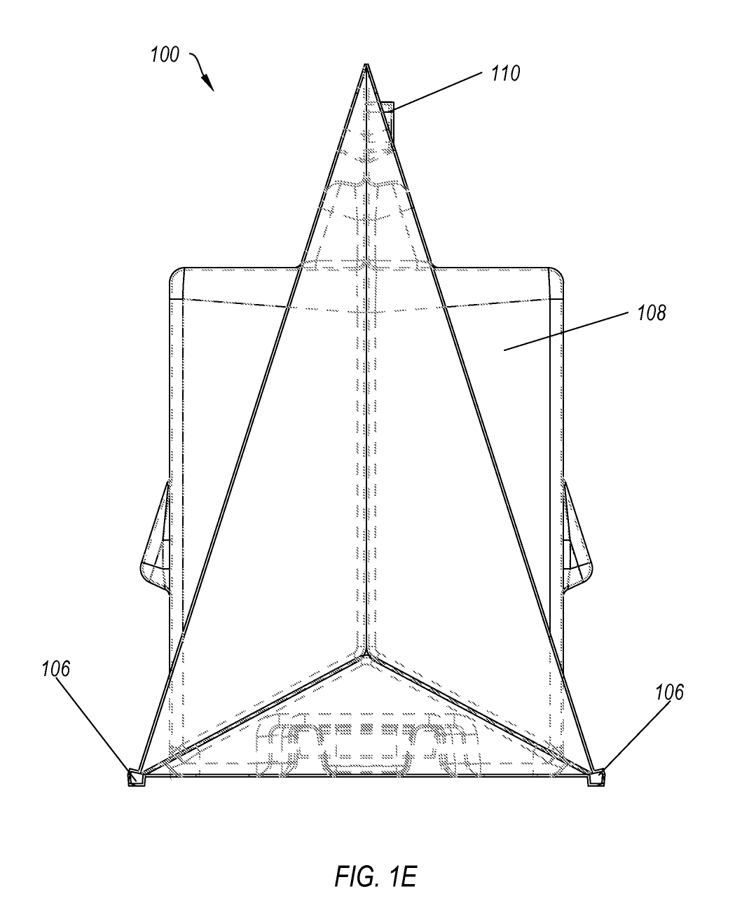

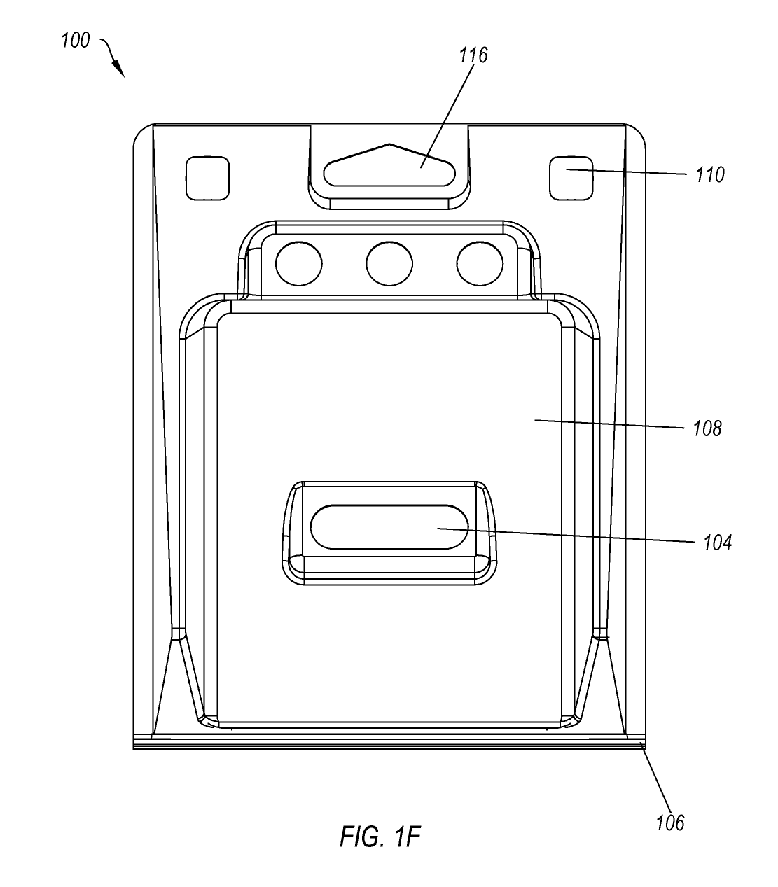

FIGS. 1A, 1B, 1C, 1D, 1E and 1F (collectively “Figure 1”) illustrate an example of a yellow jacket bait house 100. FIG. 1A illustrates a top view of an unfolded bait house 100; FIG. 1B illustrates a front view of an unfolded bait house 100; FIG. 1C illustrates a side view of an unfolded bait house 100; FIG. 1D illustrates a top perspective view of an unfolded bait house 100; FIG. 1 E illustrates a side view of a folded bait house 100; and FIG. 1F illustrates a front view of a folded bait house 100. The bait house 100 is specifically configured to allow yellow jackets to enter, come in contact with and ingest poisonous bait and return to their nest, where they will spread the poison to other yellow jackets, including larva and young yellow jackets. Thus the bait house 100 is not a “trap” meant to stop the yellow jacket from exiting and instead is configured to allow the yellow jacket to exit when desired. As used in the specification and the claims, the phrase “configured to” denotes an actual state of configuration that fundamentally ties recited elements to the physical characteristics of the recited structure. As a result, the phrase “configured to” reaches well beyond merely describing functional language or intended use since the phrase actively recites an actual state of configuration.

FIG. 1 shows that the yellow jacket bait house 100 can include a pair of opposing side panels 102. The opposing side panels 102 can form the sides of the bait house 100 when in use. I.e., the opposing side panels 102 can restrict access to the interior of the bait house 100. Likewise, the opposing side panels 102 can be separated to allow access to the interior of the bait house 100 when desired (such as when bait needs to be placed, as described below).

FIG. 1 moreover shows that the bait house 100 can include an entrance 104. The entrance 104 can include any orifice which allows yellow jackets to enter and exit the bait house 100. For example, the entrance 104 can include a hole or slot that allows yellow jackets to enter the bait house 100. The size and shape of the entrance 104 is critical to allow yellow jackets to both enter and exit the bait house 100. For example, the entrance must be large enough to allow a fully grown yellow jacket to easily enter and exit. A cone shape, for example, that prevents exiting would be unsuitable for such a purpose. Just as critical, the entrance 104 must not be so large as to allow small animals, such as mice and squirrels, to enter the bait house 100. One example of an entrance which meets these requirements includes an approximately rectangular slot (i.e., a rectangle with rounded corners or one or more rounded sides) that is approximately 1.5 inches wide and 0.44 inches high. As used in the specification and the claims, the term approximately shall mean that the value is within 10% of the stated value, unless otherwise specified.

FIG. 1 also shows that the bait house 100 can include a fold line 106. The bait house 100 can have opposing sides which are brought to one another along the fold lines 106. The fold line 106 allows the bait house 100 to be shipped in a convenient manner. In particular, the bait house 100 can be “stacked” on one another, eliminating empty space and reducing costs, such as shipping and storing costs. During use, the bait house 100 can be folded to create an inner chamber 108. In addition, the fold line allows for easy changing of the bait and poison. In particular, a user can “unfold” the bait house 100 along the fold line to access the bait. Likewise, the side panels 102 can be pivoted along the fold lines 106 to create the inner chamber 108.

FIG. 1 further shows that the bait house 100 can include an inner chamber 108. The inner chamber 108 is configured to hold bait that will act to poison yellow jackets. I.e., a yellow jacket enters the inner chamber 108 through the entrance 104 where it comes into contact with, and may ingest, the bait and poison. The yellow jacket then exits the inner chamber 108 through the entrance 104 returning the poison to the nest.

FIG. 1 additionally shows that the bait house 100 can include an attachment 110. The attachment 110 is configured to hold the bait house 100 in the folded position. I.e., the attachment 110 ensures that the bait house 100 stays in the folded position when so desired by a user. The attachment 110 can include any mechanism which retains the bait house 100 in the folded position. For example, the attachment 110 can include a snap or other interlocking connector.

FIG. 1 moreover shows that the bait house 100 can include a bait receptacle 112. The bait receptacle 112 can be configured to receive bait which will be used to attract yellow jackets. The bait receptacle 112 can receive the bait directly or can receive a bait tray, as described below. The bait receptacle 112 can make it easy for a user to place the bait within the inner chamber 108. In particular, it means that bait placement is quick, which prevents yellow jackets from being attracted to the bait house 100 while bait placement is occurring. Likewise, the bait receptacle 112 can make bait placement easy, which will make a user more likely to replace bait, making the use of the bait house 100 more effective in the long-term.

FIG. 1 also shows that the bait house 100 can include an attractant receptacle 114. The attractant receptacle 114 is configured to receive attractant which lures the yellow jackets to the bait station 100. I.e., it is a volatile chemical which attracts yellow jackets to the bait station 100 where pesticide may be administered. The attractant can be placed directly in the attractant receptacle 114 or can be placed in some other mechanism for holding the attractant. For example, the attractant can be placed on a felt pad or cotton ball located within the attractant receptacle 114.

By way of example, the attractant can include a vinegar based food grade compound or heptyl butyrate. Heptyl butyrate is a colorless liquid and is a food grade compound found abundantly in fresh apples and plums. Heptyl butyrate will not cause adverse effects to humans and other nontarget organisms when used according to label directions. Nontarget organisms, including honeybees and other beneficial insects, are not attracted to or adversely affected by the use of heptyl butyrate.

FIG. 1 further shows that the bait station 100 can include a hanger 116. The hanger 116 can allow a user to easily place the bait hose 100 in a desired location. For example, the hanger 116 can include a hole or other mechanism which allows a user to attach the bait house 100 to a desired location using an intermediate, such as string. Additionally or alternatively, the hanger 116 can include a device, such as a hook, which allows the bait house 100 to be mounted in a desired location.

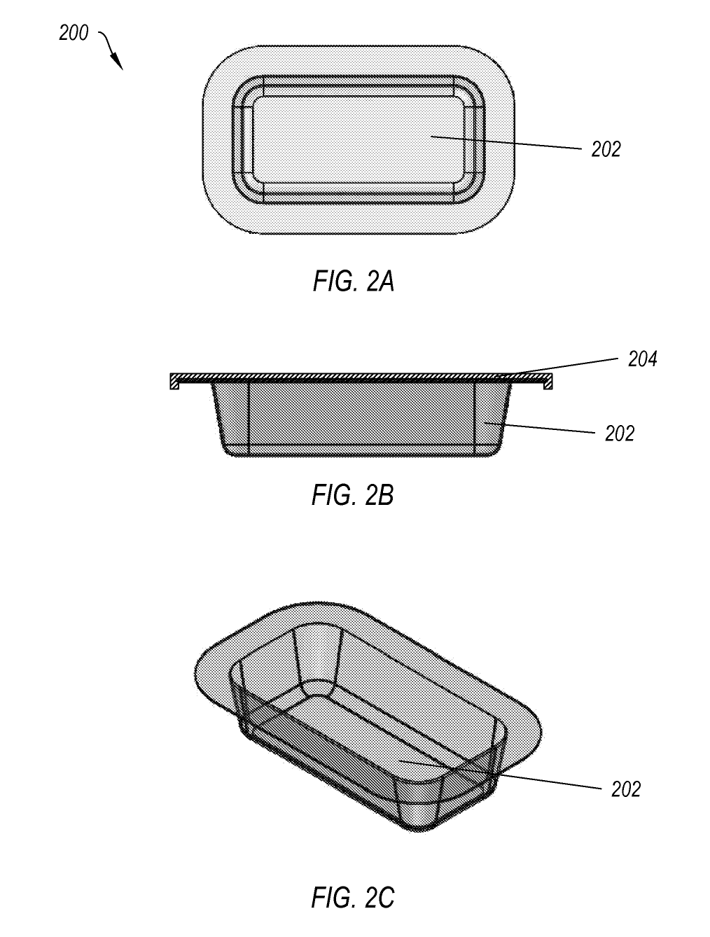

FIGS. 2A, 2B and 2C (collectively “FIG. 2”) illustrate an example of a bait tray 200. FIG. 2A illustrates a top view of a bait tray 200; FIG. 2B illustrates a side view of a bait tray 200; and FIG. 2C illustrates a top perspective view of a bait tray 200. The bait tray 200 can be configured to allow easy bait placement. For example, the bait tray 200 can be configured to be placed within the bait receptacle 112 of FIG. 1. In particular, the bait tray 200 can be pre-filled with bait and placed within a yellow jacket trap, allowing for the placement of bait to be accomplished without any contact between the user and the bait.

FIG. 2 shows that the bait tray 200 can include a container 202. The container 202 is configured to hold bait. I.e., the container 202 is the device which will contain the bait to be placed in the bait house. The container 202 can be made of plastic or another impermeable material, allowing it to be handled without becoming contaminated and without a user coming into direct contact with the bait.

The user places the bait by opening the bait house and removing a used bait tray (if present). The user adds bait food and water to the bait tray 200. During the first use, only bait without insecticide may be used. However, during subsequent uses the user will then add 6-8 drops of Insecticide to cover the bait. The number of drops is critical as more than 8 drops will repel yellow jackets. Therefore, the user can adjust the timing of bait placement to maximize the removal of yellow jackets.

FIG. 2 further shows that the bait tray 200 can include bait. Examples of bait which can be used with the invention include any meat byproduct or protein mixture which is configured to be ingested by yellow jackets. I.e., the bait includes any protein mixture which yellow jackets will ingest. The meat byproduct is laced with a pesticide which will kill yellow jackets after ingestion and/or contact with the pesticide.

Examples of a pesticide which can be introduced into the bait include any pesticide which works thorough ingestion or absorption and which is slow to kill yellow jackets. I.e., the pesticide causes death slowly enough for the yellow jacket to return to the nest, where the pesticide is spread to other yellow jackets, particularly young yellow jackets and larvae. For example, the pesticide can include fipronil (5-amino-1-(2,6-dichloro-4-(trifluoromethyl)phenyl)-4-((1,R,S)(trifluoromethyl)sulfinyl)-1-H-pyrazole-3-carbonitrile) with a concentration of approximately 0.025% relative to the meat byproduct. A concentration of approximately 0.025% can be critical to ensure that the dosage to a yellow jacket is fatal but acts slowly, allowing the yellow jacket to return to the nest where the fipronil is shared with other yellow jackets and larvae.

Fipronil works through both contact and ingestion. Fipronil is added to the bait station and will poison an insect by simply making contact with fipronil or ingesting a fipronil-based bait. Once absorbed through the insect's outside skin or ingested, fipronil's ingredients launch a slow, deadly attack on the insect's central nervous system. This attack sends the insect's nerves and muscles into hyper-excitation, leaving it unable to perform basic functions like grooming and feeding itself. Eventually, the affected insect will die, but not before returning to the colony and passing the poison to others through physical contact, feces, and bait sharing.

By way of example, a method of use is described herein. The method of use herein is not limiting unless otherwise specified in the claims. Initial set-up can include the steps: 1. Open Bait Station and remove all contents; 2. Remove Felt Pad and place in Felt Pad Receptacle. Squeeze all of the liquid content in the Attractant Tube onto the Felt Pad; 3. Remove one (1) bait tray, bait food packet and spoon. Add one (1) level spoonful of bait food to the bait tray. Add one (1) level spoonful of water to bait tray. Wait 1-2 minutes for bait to absorb the water. Do not add insecticide to the bait the first day. Remember you are training the wasp(s) on where to find food; 4. Insert loaded Bait Tray into Bait Tray receptacle; 5. Close the Bait Station and press your fingers together on the button snap closures; 6. Take the loaded Bait Station and Twist Tie outdoors to hanging location; 7. Attach the Twist Tie to the hanger opening at the top of the Bait Station. Wrap the Twist Tie at least two (2) times around itself for secure attachment; 8. Hang the Bait Station a minimum of 20 feet away from any known nest. Keep the Bait Station away from your house or any outdoor living area; 9. Hang the Bait Station in a shaded area for best results. NOTE: Using the Twist Tie, hang the Bait Station from a tree branch (or other hanging location) high enough from the ground that it cannot be reached by family pets or children; 10. Wash hands thoroughly with soap and water immediately after handling Bait Station.

By way of example, a method of continued use is described herein. The method of use herein is not limiting unless otherwise specified in the claims. Continued use can include the steps: 1. Check Bait Station for wasps. If wasps are present, do not attempt to change the bait; 2. If wasps are not present, remove the Bait Station from the Twist Tie; 3. Open Bait Station and remove used Bait Tray. Use a NEW Bait Tray and add 1 level spoonful of bait food and 1 level spoonful of water. Wait 1-2 minutes for bait to absorb the water. NOW, Shake Insecticide bottle well. Then add 6-8 drops of Insecticide to cover the Bait. Important : More than 8 drops will repel wasps. NOTE: Wasps will not eat spoiled meat. For best results, replace bait tray and bait every morning for 5 consecutive days; 4. Re-hang the Bait Station with the Twist Tie from the bait station hanger opening; 5. Dispose of the used Bait Tray and bait into your trash receptacle; 6. Wash hands thoroughly with soap and water immediately after re-hanging the Bait Station and after handling the used Bait Trays.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bait house for bringing yellow jackets into proximity to a pesticide which is brought back to the nest, the bait house comprising:
a pair of opposing side panels;
an entrance formed in at least one of the side panels, wherein the entrance is configured to:
allow a yellow jacket to enter the bait house; and
allow a yellow jacket to exit the bait house; and
an integrally molded bait receptacle attached to the side panels by fold lines;
wherein the side panels pivot along the fold lines to engage each other and the central tray form an enclosed volume.

2. The bait house of claim 1, wherein the entrance is approximately 1.5 inches wide.

3. The bait house of claim 1, wherein the entrance is approximately 0.44 inches high.

4. The bait house of claim 1 further comprising an attachment, wherein the attachment is configured to secure the opposing side panels to one another when engaged.

5. The bait house of claim 1, wherein the bait receptacle is configured to receive a bait tray.

6. The bait house of claim 5, wherein the bait tray includes a container containing bait.

7. The bait house of claim 6, wherein the bait includes a meat byproduct.

8. The bait house of claim 7, wherein the bait includes a pesticide.

9. The bait house of claim 8, wherein the pesticide includes Fipronil.

10. The bait house of claim 9, wherein the ratio of Fipronil is approximately 0.025 percent.

11. A bait house for bringing yellow jackets into proximity to a pesticide which is brought back to the nest, the bait house comprising:
a pair of opposing side panels;
an entrance formed in at least one of the side panels, wherein the entrance is configured to:
allow a yellow jacket to enter the bait house; and
allow a yellow jacket to exit the bait house;
an integrally molded bait receptacle attached to the side panels by fold lines, wherein the bait receptacle is configured to receive a bait tray;
wherein the side panels pivot along the fold lines to engage each other and the central tray form an enclosed volume; and
an attachment, wherein the attachment is configured to secure the opposing side panels to one another when engaged.

12. The bait house of claim 11 further comprising an attractant receptacle configured to receive attractant.

13. The bait house of claim 11, wherein the attractant includes heptyl butyrate.

14. The bait house of claim 11, wherein the attractant includes a vinegar compound.

15. The bait house of claim 11, wherein the attractant is placed on a cotton ball.

16. The bait house of claim 11, wherein the attractant is placed on a felt pad.

17. A bait house for bringing yellow jackets into proximity to a pesticide which is brought back to the nest, the bait house comprising:
a pair of opposing side panels;
an entrance formed in at least one of the side panels, wherein the entrance is configured to:
allow a yellow jacket to enter the bait house; and
allow a yellow jacket to exit the bait house;
an integrally molded bait receptacle attached to the side panels by fold lines, wherein the bait receptacle is configured to receive a bait tray;
a bait tray within the bait receptacle, wherein the bait tray includes:
a container containing bait;
wherein the side panels pivot along the fold lines to engage each other and the central tray form an enclosed volume; and
an attachment, wherein the attachment is configured to secure the opposing side panels to one another when engaged; and
a hanger, wherein the hanger is configured to allow placement of the bait house by a user.

18. The bait house of claim 17, wherein the attractant receptacle is configured to receive a cotton ball.

19. The bait house of claim 17, wherein the attractant receptacle is configured to receive a felt pad.
